(19) United States
(12) Patent Application Publication
(10) Pub. No.: US 2007/0292647 A1
(43) Pub. Date: Dec. 20, 2007

(54) Lap and seam seal closure system for foam pipe insulation

(76) Inventor: Charles M. Princell, Graham, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/454,438

(22) Filed: Jun. 16, 2006

(51) Int. Cl. B32B 1/08; B32B 33/00

(52) U.S. Cl. 428/36.9; 428/40.1

(57) ABSTRACT

The present invention provides, among other things, a new pipe insulation system that includes a reinforced, elastic foam lap seal closure system that can maintain the integrity of the protective closure around a pipe to be insulated, and can minimize seal failures. One aspect of this invention is the novel closure system that combines a seam seal vapor barrier with a reinforced elastic foam lap seal which bolsters seal integrity and helps prevents seam closure failure.

### FIELD OF THE INVENTION

The present invention relates to pipe insulation materials, including flexible foam pipe insulation materials, and more particularly to lap and seam sealing means for pipe insulation.

### BACKGROUND OF THE INVENTION

The use of flexible foam insulation materials constitutes an important aspect of sealing and protecting pipes and isolating them from their surrounding environment. Foam insulation is typically fabricated into a tube by extruding a polymer, for example polyethylene, polypropylene, vinyl resins, or elastomers such as EPDM (ethylene propylene diene rubber) or vinyl nitrile, followed by post-extrusion foaming of the polymers using chemical or physical foaming agents that impart a closed microcellular structure to the extruded tube. One step in this fabrication process typically involves slitting the insulation tube longitudinally through one wall of the annular profile, for later application to a pipe. A vapor/moisture barrier adhesive coating is then applied to at least one exposed edge of the wall of the slit tube to secure the seam together to form a moisture/vapor resistant seal once the tube is placed around the pipe to be insulated.

In addition to including a seam seal, typical foam pipe insulation can incorporate a lap seal formed from a strip or tape of sealing material that is applied longitudinally along and generally centered over the seam seal, such that the slit roughly bisects the longitudinal axis of the lap seal strip or tape. This sealing strip usually is secured to the outer surface of the foam insulation by an adhesive applied to one side thereof and can be protected by a removable release liner, in order to achieve the lap seal once the section of insulation is in place around the pipe. One useful aspect of a lap seal is the protection and reinforcement that it can afford the seam seal.

One problem associated with these conventional “peel and seal” foam insulation products is encountered when they are installed on change-of-direction pipe fittings, such as 90° elbows or “P” traps, in which the stress of installing the insulation around the directional fitting can result in seam failure. In such a situation, the lap seal tape and seam seal adhesives can fail or pull away from the insulation material under the stress load, often due to buckling, and accordingly can result in loss of insulation properties and possible peripheral water damage arising from water vapor condensation on the exposed pipe surface.

Therefore, there is a need for a foam insulation material that addresses the foregoing and other related and unrelated problems in the art while affording desired insulation properties.

### SUMMARY OF THE INVENTION

The present invention is drawn to, among other things, a pipe insulation system that includes a reinforced, elastic foam lap seal closure system that can maintain the integrity of the dual-seal protective closure around a pipe to be insulated, and can minimize or substantially eliminate seal failures. One aspect of this invention is the novel closure system that combines a seam seal vapor barrier with a reinforced elastic foam lap seal that bolsters seal integrity and prevents seam closure failure. Thus, the reinforced elastic foam lap seal helps substantially eliminate peripheral component damage caused by water vapor condensation from exposed pipe surfaces when seals fail.

In another aspect, the present invention provides a lap seal tape structure that includes an elastic layer which can be an elastic foam layer, a mesh reinforcement layer of various natural or synthetic fibers, and an adhesive such as a pressure-sensitive adhesive (PSA) to form the lap seal. The elasticity of the lap tape structure imparted by the elastic layer, in conjunction with the mesh reinforcement layer permits the lap seal tape to conform to change-of direction piping without buckling of lifting from the insulation surface. Further, the mesh reinforcement layer assists in controlling the elongation of the elastic layer, which otherwise would be transferred to the seam seal. Thus, the lap seal tape structure of the present invention includes a material such as a foam material that is characterized by, among other things, its elasticity. Accordingly, in one aspect, the resultant pipe insulation system of the present invention generally comprises: a) a tubular structure of an insulation material that is adapted to form a seam seal along the length of the tubular structure; and b) a lap seal tape structure comprising an elastic layer, a mesh reinforcement layer, and a lap seal tape adhesive layer, that is adapted to form a lap seal over the seam seal to further enclose, seal, and protect pipes from their surrounding environment, and typically a lap seal tape release liner. In this aspect, this invention encompasses the pipe insulation system as described herein in its unsealed form.

In still a further aspect, this invention provides a method of sealing pipes comprising enclosing a pipe in the pipe insulation system as disclosed herein. This invention further encompasses a sealed pipe that has been enclosed using the pipe insulation system disclosed herein.

These and other features, aspects, embodiments, and advantages of the present invention will become apparent after a review of the following detailed description of the invention. It should be understood, however, that these aspects, embodiments, and examples are provided for illustrative purposes only, and are not to be construed in any way as imposing limitations upon the scope thereof.

### BRIEF DESCRIPTION OF THE FIGURES

FIG. 1 is a perspective view of the pipe insulation system of this invention prior to being installed on a pipe, in which neither the seam seal nor the lap seal are closed or formed.

FIG. 2 is a perspective view of the pipe insulation system of this invention partially installed on a pipe. In this view, neither the seam seal nor the lap seal are closed or formed.

FIG. 3 is an end view of the pipe insulation system of this invention installed on a pipe and held in the fully closed or sealed position by both the seam seal and the lap seal.

FIG. 4 is a perspective view of the tubular structure of the pipe insulation system of this invention, emphasizing the mating surfaces, the mating surface adhesive layer, and the mating surface release liner.

FIG. 5 is a perspective view of the lap seal tape structure of the pipe insulation system of this invention, in which portions of the mesh reinforcement layer, the lap seal tape adhesive layer, and the lap seal tape release liner have been removed.

FIG. 6 is a view of some non-limiting examples of structures of the mesh reinforcement layers that can be used in the lap seal tape structure of the present invention.

### DETAILED DESCRIPTION OF THE INVENTION

In accordance with the present invention, a pipe insulation system is provided having a tubular structure of insulation material with an outer surface, an inner surface, and a body extending between the inner and the outer surface, and a bore of a suitable size to receive a pipe, which generally can be of any desired length. This tubular structure is longitudinally split through one wall of the annular tube body by way of a radial slit, along the length of the tube, for ease of installation on the pipe. Further, the pipe insulation system encompasses a closure system that provides two seals which employ a suitable adhesive such as a pressure sensitive adhesive: a seam seal and a lap seal. Generally, the seam seal forms a first moisture/vapor barrier between the pipe and the outside environment, while the reinforced elastic lap seal strengthens and reinforces the seam seal and provides an additional moisture/vapor barrier between the pipe and the outside environment.

In one aspect of this invention, the seam seal typically comprises a pressure-sensitive adhesive in combination with a protective release liner applied longitudinally to one face or mating surface along the longitudinal split in the tube. The vapor barrier seam seal can be formed by applying an adhesive to one or both of the two opposed mating surfaces that arise upon splitting the tube, which can be further protected by a release liner as required until the pipe insulation system is ready for use. This seam seal aids in providing a moisture/vapor barrier that substantially minimizes exposure of the pipe to the atmosphere, which minimizes heat transfer, moisture condensation, and the like at the pipe surface.

In another aspect of this invention, the lap seal is formed using a lap seal tape structure that can also comprises a pressure-sensitive adhesive in combination with a protective release liner. The lap seal tape structure can be a reinforced elastic foam lap seal tape structure that can be applied longitudinally to the pipe insulation surface over the seam seal. A portion, typically about one-half, of the lap seal tape's area along the length of the tape is pre-adhered to the outer surface of the tubular surface, such that the radial slit through the insulation body approximately bisects the lap seal tape in a lengthwise fashion. By retaining the other portion of the release liner along the unattached portion of the lap seal tape, the second portion of the lap seal tape's area can be adhered to the outer surface of the tubular structure on the opposite side of the radial slit, once the seam seal is formed, thereby completing the lap seal. When the pipe insulation system is placed around pipe to be protected, the respective mating surfaces of the seam seal and the adhesive layer of the lap seal are substantially perpendicular to each other.

Thus, the present invention provides, in one aspect, a pipe insulation system comprising:

a) a tubular structure of an insulation material defining a longitudinal axis, wherein the tubular structure comprises:
i) a substantially cylindrical outer surface,
ii) a substantially cylindrical inner surface defining a longitudinally extending passage, and
iii) a body extending between the cylindrical outer surface and the cylindrical inner surface and having a radially extending thickness; and
iv) a radial slit extending through the body parallel to the longitudinal axis of the tubular structure for the length of the tubular structure, wherein

the radial slit defines a first mating surface and a second mating surface; and

b) a lap seal tape structure having a longitudinal axis, a proximal face, and a distal face, wherein the longitudinal axis of the lap seal tape structure extends substantially parallel to the longitudinal axis of the tubular structure for the length of the tubular structure, and the lap seal tape structure comprising:
i) an elastic layer having an inner surface and an outer surface, the outer surface forming the distal face of the lap seal tape structure;
ii) a mesh reinforcement layer applied to the inner surface of the elastic layer; and
iii) a lap seal tape adhesive layer having at least a portion bonded to the mesh reinforcement layer and the elastic layer and forming the proximal face of the lap seal tape structure;

wherein a portion of the lap seal tape structure is bonded to the outer surface of the tubular structure on one side of the radial slit by engagement of at least a portion of the lap seal tape adhesive layer, such that the radial slit extends substantially along the length of the lap seal tape structure and defines the portion of the lap seal tape adhesive layer bonded to the outer surface of the tubular structure.

This invention also encompasses the pipe insulation system disclosed herein in its sealed form, in which the both the seam seal and the lap seal of the pipe insulation system are formed and closed, and a pipe is enclosed therein. In this aspect, the pipe insulation system substantially surrounds and insulates a pipe and can enclose a pipe that includes bends or change-of-direction pipe fittings, such as 90° elbows or “P” traps, such that the pipe insulation system structure itself is adapted to seal bends or change-of-direction pipe fittings with extended seal lifetimes. In this aspect, this invention encompasses a pipe insulation system as described above, wherein at least one of the first mating surface and the second mating surface is at least partially coated with a mating surface adhesive layer, and wherein at least one optional mating surface release liner substantially covers and is releasably attached to the mating surface adhesive. Upon situating the tube in place around the pipe to be insulated and removing the release liner(s) to expose the adhesive, the seam seal can be formed by aligning and contacting the mating surfaces of the insulation to adhere the mating surfaces to each other, and to form the tubular jacket around the pipe. Once the seam seal is formed, the lap seal can be completed by attaching the lap seal tape structure to the outer surface of the tubular structure by way of the lap seal tape adhesive layer, such that the radial slit extends substantially the length of the lap seal tape structure, and such that the lap seal tape structure is bonded to the outer surface of the tubular structure on both sides of the radial slit. Alternatively, the seam seal or a portion thereof can be formed by adhering the mating surfaces to each other first, then the lap seal can be completed by attaching the lap seal tape structure to the outer surface of the tubular structure as described above, after which the sealed tube can be pushed into place around the pipe to be insulated, such as a change-of-direction fitting.

In another aspect, this invention provides for a lap seal tape structure itself comprising:

a) an elastic layer;

b) a mesh reinforcement layer applied to one surface of the elastic layer and substantially coextensive with the elastic layer; and

c) a lap seal tape adhesive layer bonded to the mesh reinforcement layer and the elastic layer and substantially coextensive with the mesh reinforcement layer.

In this aspect, the lap seal tape structure can further comprise a lap seal tape release liner releasably attached to the lap seal tape adhesive layer and extending substantially coextensive with the lap seal tape adhesive layer. Also in this aspect, the adhesive layer can encompass multiple functions, including, but not limited to, adhering the mesh reinforcement layer to one surface of the elastic layer and adhering the combined elastic layer-mesh reinforcement layer structure to the outer surface of the tubular structure.

In another aspect of this invention, the mesh reinforcement layer can be substantially encapsulated in the adhesive layer, which is affixed to the elastic layer. In this aspect, the lap seal tape structure can be fabricated in any manner, for example, by applying the lap seal tape adhesive layer directly to the elastic layer, followed by applying the mesh layer to adhesive layer such that substantially encapsulation of the mesh in the adhesive layer occurs. Alternatively, the mesh reinforcement layer can be applied or attached to the elastic layer, followed by application of the adhesive layer, such that substantial encapsulation of the mesh in the adhesive layer occurs. Thus, the lap seal tape structure is not limited to any particular fabrication method. In this aspect, the lap seal tape adhesive layer is in contact with both the elastic layer and the mesh layer. Further, we note that the mesh reinforcement layer can be only partially encapsulated in the lap seal tape adhesive layer. For example, about 20% of the mesh reinforcement layer can be encapsulated in the lap seal tape adhesive layer, about 40% of the mesh reinforcement layer can be encapsulated in the lap seal tape adhesive layer, about 60% of the mesh reinforcement layer can be encapsulated in the lap seal tape adhesive layer, about 80% of the mesh reinforcement layer can be encapsulated in the lap seal tape adhesive layer, or about 100% of the mesh reinforcement layer can be encapsulated in the lap seal tape adhesive layer.

In another aspect, the mesh reinforcement layer can be attached to the inner surface of the elastic layer by any number of methods. For example, the mesh reinforcement layer can be attached to the inner surface of the elastic layer such as an elastic foam layer by using an adhesive as provided above, or during the fabrication process while the extruded polymer is still soft, or by any other method, as long as the flexibililty/elasticity of the lap tape structure is not destroyed. When an adhesive is used, the adhesive can include, but is not limited to, a pressure sensitive adhesive. Because the reinforcement layer has a mesh structure, the lap seal tape adhesive layer is typically in direct contact with the elastic layer through the openings in the mesh. In a further aspect, the mating surface adhesive layer and the lap seal tape adhesive layer are typically a pressure-sensitive adhesives, which provide for convenient installation of the pipe insulation system. Further, the use of pressure-sensitive adhesives, usually in combination with their respective release strips, is more environmentally green then more traditional adhesives which typically release volatile organic compounds upon curing.

In one aspect, the mesh reinforcement layer of the lap seal tape structure typically is substantially coextensive with the elastic layer, with the lap seal tape adhesive layer being bonded to the mesh reinforcement layer and the elastic layer and substantially coextensive with the mesh reinforcement layer. Further, the lap seal tape release liner, when present, can be substantially coextensive with the lap seal tape adhesive layer, or alternatively, can be releasably attached to only a portion of the lap seal tape adhesive layer. Such features are not, however, requirements of the lap seal tape structure. For example, the mesh reinforcement layer can be more than or less than coextensive with the elastic layer. Further, the lap seal tape adhesive layer can be more than or less than coextensive with the mesh reinforcement layer. The latter feature of the lap seal tape structure could be useful where, for example, a portion of the lap seal tape structure is bonded to the outer surface of the tubular structure on one side of the radial slit by way of essentially the entire lap seal tape adhesive layer, such that the portion of the lap seal tape structure unbonded to the outer surface of the tubular structure is not coated with an adhesive. Such a structure can be useful, for example, as a predecessor to the structure in which the lap seal is fully formed.

In one aspect of this invention, because the typical mating surface adhesive layer used to form the seam seal and the typical lap seal tape adhesive layer used to form the lap seal are pressure-sensitive adhesives (PSAs), the pipe insulation system of this invention typically includes release liners for both the mating surface and for the lap seal tape. In this aspect, the lap seal tape release liner can be substantially coextensive with the lap seal tape adhesive layer or it can be substantially coextensive with the portion of the lap seal tape structure that is not bonded to the outer surface of the tubular structure on one side of the radial slit by way of a portion of the lap seal tape adhesive layer. Thus, in this aspect, when a portion of the lap seal tape structure is bonded to the outer surface of the tubular structure on one side of the radial slit, only the exposed, unattached portion of the lap seal tape adhesive layer typically has the optional lap seal tape release liner releasably attached thereto. In this aspect, the optional lap seal tape release liner is not substantially coextensive with the entire lap seal tape adhesive layer, but is only releasably attached to a portion of the lap seal tape adhesive layer.

In one aspect, the pipe insulation system of the present invention can utilize a tubular structure of insulation material of substantially any size. For example, the tubular structure can have a radially extending thickness from about 0.10 inches to about 10 inches. In a further aspect, the tubular structure can have a radially extending thickness from about 0.2 inches to about 6 inches, from about 0.3 inches to about 4 inches, or from about 0.4 inches to about 2 inches.

Any number of suitable pipe insulation materials can be used to form the tubular structure in this invention, including, but not limited to, polyurethane, polyethylene, polypropylene, polystyrene, poly(vinyl chloride), synthetic butadiene rubber, polyamide, poly(ethylene-co-vinyl-acetate), poly(ethylene-propylene-diene), styrene-butadiene-rubber, neoprene, polyisoprene, polychloroprene, and the like, including any combination thereof. Typically, in one aspect, the insulation material used to fabricate the tubular structure is foamed, although non-foamed insulation materials can also be used. Foam insulation material that can be used in the tubular structure typically can be low density foam, for example, from about 7 to about 1 lb/ft³ in density, however foam materials having densities higher and lower can be used. Thus, foam materials that constitute the tubular structure can have a density of from about 6 to about 2 lb/ft³, from about 5 to about 3 lb/ft³, or from about 4.5 to about 3.5 lb/ft³.

A wide variety of adhesive materials can be used form forming the seam seal and the lap seal in the pipe insulation system of this invention, as understood by one of ordinary skill in the art. In one aspect, the seam seal typically comprises a pressure-sensitive adhesive (PSA) such as a hot-melt PSA or an acrylic adhesive coating applied longitudinally to one or both mating surfaces, typically in combination with a protective release liner applied to the adhesive, such that the mating surfaces can be bonded together once the pipe is enclosed. The lap seal also typically comprises a PSA such as a hot-melt PSA or an acrylic adhesive coating applied to the mesh reinforcement layer, also usually in combination with a protective release liner applied to the adhesive. The seam seal adhesive and the lap seal adhesive can be the same or they can be different, however, any adhesive known to one of ordinary skill in the relevant art can be utilized. Thus, in one aspect, suitable adhesives include, but are not limited to, thermoplastic PSAs such as hot melt adhesives, acryl-based PSAs, rubber-based PSAs, PSAs of any other type, and the like. In another aspect, the PSAs employed herein can be selected, independently, from natural rubbers, synthetic rubbers, block copolymers, (meth)acrylates, silicones, or olefins. In still another aspect, suitable PSAs include those designed for either permanent or removable applications, and in another aspect, suitable PSAs include those PSAs that can be initially removable to allow resituating the seal, that then slowly increase adhesion to a more permanent bond after a period of several hours or days.

Further, the present invention encompasses the pipe insulation system in both its unsealed, open form and its sealed, closed form. In its sealed state, the seam seal alone can be formed by way of the mating surface adhesive layer, the lap seal alone can be formed by way of the lap seal tape adhesive layer, or both the seam seal and the lap seal can be formed. Thus, while most applications of the pipe insulation system disclosed herein will likely utilize both the seam seal and the lap seal to afford a better seal and enhanced protection and isolation of pipes from their surrounding environment, it is not necessary that both seal be used in the sealed state of the pipe insulation system of this invention. In its unsealed form, the proximal face of the lap seal tape structure is substantially perpendicular to the mating surface situated on the same side of the radial slit as the lap seal tape structure. In its sealed form, the proximal face of the lap seal tape structure is substantially perpendicular to both mating surfaces of the lap seal tape structure.

The pipe insulation system also can include at least one optional second radial slit in the tubular structure, to aid in opening the tubular structure and installing it around a pipe to be protected. In this aspect, and in addition to a first radial slit that extends through the body of the tubular structure, the tubular structure can further comprise a second radial slit in the inner surface of the tubular structure, extending only partially through the body and extending parallel to the longitudinal axis of the tubular structure for the length of the tubular structure, and situated substantially opposite the radial slit that extends through the body, wherein the second radial slit forms a longitudinally extending hinge in the tubular structure. This longitudinally extending hinge assists in opening the tubular structure and installing it around a pipe. The second radial slit can have a depth from about 0.9 times to about 0.1 times the radially extending thickness of the tubular structure body, and more particularly, can have a depth from about 0.25 times to about 0.80 times, or from about 0.50 times to about 0.75 times, the radially extending thickness of the tubular structure body.

Another aspect of this invention provides the lap seal tape structure itself, which is generally characterized by its flexible or elastic behavior. Thus, the lap seal tape structure can include: i) an elastic layer; ii) a mesh reinforcement layer; and iii) a lap seal tape adhesive layer. The lap seal tape structure can further include a lap seal tape release liner that is attached releasably to the lap seal tape adhesive layer. Further, the elastic layer can be an elastic foam layer or the elastic layer can comprise an elastic foam layer. The elastic layer of the lap seal tape structure generally provides for the flexibility exhibited by this structure. In one aspect, the elastic layer can be a closed-cell foam layer. In another aspect, the mesh reinforcement layer can be a scrim mesh layer. When combined into the complete lap seal tape structure, the combination of layers provides for a reinforced elastic foam lap seal tape, the flexibility of which permits seal integrity to be maintained, even when installed around change-of-direction fittings. Any number of suitable foam materials can be used in the lap seal tape structure of this invention, including, but not limited to, polyurethane, polyethylene, polypropylene, polystyrene, poly(vinyl chloride), synthetic butadiene rubber, polyamide, poly(ethylene-co-vinyl-acetate), poly(ethylene-propylene-diene), styrene-butadiene-rubber, neoprene, polyisoprene, polychloroprene, and the like, or any combination thereof. The foam materials utilized typically can be low density foams, for example, from about 7 to about 1 lb/ft³ in density, however foam materials having densities higher and lower can be used. In one aspect, the foam materials that constitute the elastic foam layer of the lap seal tape can have a density of from about 6 to about 2 lb/ft³, from about 5 to about 3 lb/ft³, or from about 4.5 to about 3.5 lb/ft³.

In a further aspect, the mesh reinforcement layer can be formed from any suitable material that provides structural strength and/or support to the elastic layer to form the lap seal. While not intending to be bound by theory, it is thought that one reason the inventive lap seal tape structure and pipe insulation system work well is because the mesh reinforcement layer is securely affixed to the elastic layer, typically an elastic foam layer. The integrity of the mesh layer-elastic layer interface, as well as the particular mesh used, are thought to provide the proper balance between permitting sufficient elastic elongation of the lap seal tape structure to conform to any bend in a pipe, while not allowing excessive elongation of the lap seal tape structure resulting in overextension and loss of integrity of the lap and seam seals. Thus, the integrity of the mesh layer-elastic layer interface, as well as the particular mesh used, are thought to largely determine the elastic layer strain limit provided by the structure of the mesh reinforcement layer.

Examples of suitable mesh reinforcement layer materials include, but are not limited to, woven or non-woven textiles made from either natural fibers or synthetic fibers. Examples of suitable natural fibers include, but are not limited to, cotton, wool, flax, linen, hemp, jute, silk, ramie, sisal, and the like. Examples of suitable synthetic materials include, but are not limited to, rayon, acetate, nylon, modacrylate, polyolefin, polyester, acrylic polymers, polyacrylonitrile, polyethylene terephthalate (PET), aramid, vinalon, fiberglass, and the like. Useful mesh reinforcement layer materials can also be in a variety of forms, for example, cotton materials can be used in the form of scrim mesh, gauze, cheesecloth, and the like. In one aspect, reinforcing scrim mesh material can be used. The strand thickness and geometry of the mesh reinforcement layer are selected such that the lap seal tape structure that contains the mesh reinforcement layer has sufficient elastic elongation capability in order to conform to a pipe's bends and angles, yet still has sufficient strength to prevent it from over-extension, weakening, tearing, or other means by which the integrity of the lap seal tape structure and lap seal can be compromised.

Moreover, in another aspect, the mesh reinforcement layer can comprise a composite layer of suitable materials. For example, a layer of reinforcing scrim can be bonded to additional layers that include glass fibers, carbon fibers, hemp fibers, and the like, typically using an adhesive, to afford a composite mesh reinforcement layer. In this aspect, for example, a paper/foil/scrim composite material can be used that forms a suitable vapor barrier.

In one aspect of this invention, when the elastic layer of the lap seal tape structure is a closed-cell foam layer, the foam is typically a low density foam having a density, for example, from about 7 to about 1 lb/ft³. However, it is not necessary that the elastic foam layer have a density within this range, as foam layers having densities higher and lower can be used. In another aspect, the elastic foam layer of the lap seal tape structure can have a density of from about 6 to about 2 lb/ft³. In still another aspect, the closed cell elastic foam layer of the lap seal tape structure can have a density of from about 5 to about 3 lb/ft³, or from about 4.5 to about 3.5 lb/ft³. Further, the closed cell elastic foam layer of the lap seal tape structure can have a density of about 7 lb/ft³, about 6 lb/ft³, about 5 lb/ft³, about 4 lb/ft³, about 3 lb/ft³, about 2 lb/ft³, or about 1 lb/ft³.

Moreover, the lap seal tape structure can vary in width, but in one aspect, the lap seal tape structure can be from about 0.25 inches to about 6 inches in width. However, it is not necessary that the lap seal tape structure have a density within this range, as lap seal tape structures that are wider or more narrow can be used. In another aspect, the lap seal tape structure can be from about 0.50 inches to about 5 inches in width, from about 0.75 inches to about 4 inches in width, from about 1 inch to about 3 inches in width, or from about 1.25 inches to about 2 inches in width. In a further aspect, the lap seal tape structure can be about 0.25 inches, about 0.50 inches, about 0.75 inches, about 1.00 inch, about 1.25 inches, about 1.50 inches, about 1.75 inches, about 2.00 inches, about 2.25 inches, about 2.50 inches, about 2.75 inches, about 3.00 inches, about 3.25 inches, about 3.50 inches, about 3.75 inches, or about 4.00 inches in width.

In a further aspect of this invention, the lap seal tape structure can also vary considerably in thickness, for example, the elastic layer of the lap seal tape structure can be from about 0.010 inches to about 0.30 inches in thickness. The mesh reinforcement layer and lap seal tape adhesive layer will each contribute a thickness which, along with the elastic layer thickness, contributes to the overall thickness of the lap seal tape structure. It is not necessary that the elastic layer of the lap seal tape structure have a thickness within this stated range, as elastic layers that are more or less thick can be used. In yet another aspect, the foam lap seal tape structure can be from about 0.02 inches to about 0.25 inches, from about 0.03 inches to about 0.20 inches, from about 0.04 inches to about 0.15 inches, or from about 0.05 to about 0.10 inches in thickness.

In still another aspect of this invention, the water vapor permeance of the installed pipe insulation system of this invention, can vary according to the thickness of the tubular structure, the thickness of the lap seal tape structure, the quality of the seam and lap seals, and the like, of the sealed pipe insulation system. The water vapor permeability of the insulation material that makes up the tubular structure contributes to a great extent to the overall permeance of the installed pipe insulation system. In one aspect, the water vapor permeability rating of the insulation material used in the tubular structure can be about 0.05 perm or less. In another aspect, the water vapor permeability rating of the insulation material can be about 0.04 perm or less, about 0.03 perm or less, about 0.02 perm or less, or about 0.01 perm or less.

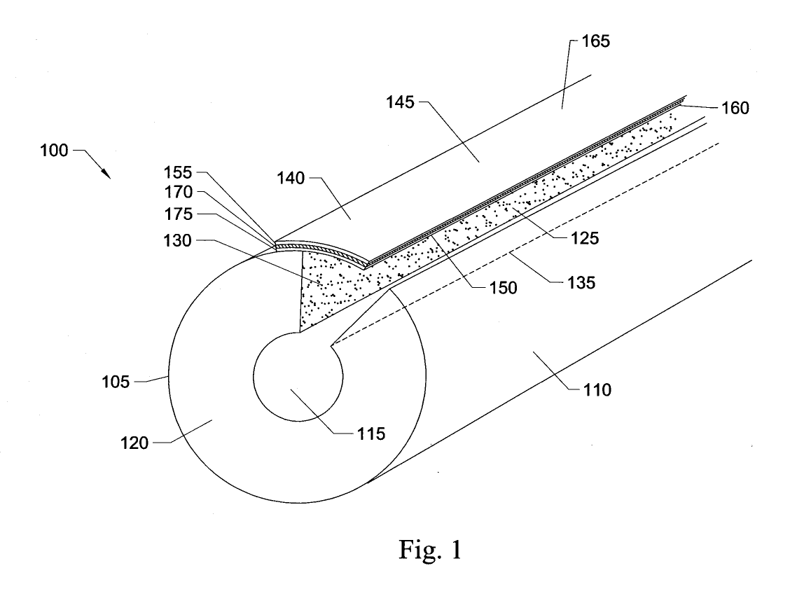

FIGS. 1-5 illustrate one exemplary embodiment of a pipe insulation system 100 according to the principles of the present invention. As illustrated in FIG. 1, the pipe insulation system 100 is shown prior to being installed on a pipe, and in which neither the seam seal nor the lap seal have been formed. The pipe insulation system 100 comprises, among other things, tubular structure 105 having an outer surface 110 and an inner surface 115, a body 120 sandwiched between the inner and outer surfaces and having a radially extending thickness, and a radial slit 125 defining a first mating surface 130 and a second mating surface 135, indicated in dashed lines. The pipe insulation system 100 further comprises a lap seal tape structure 140 having a proximal face 145 that is generally closer to the tubular structure 105 and which is hidden in this view, and distal face 150 that is further from the tubular structure 105. The lap seal tape structure 140 generally comprises, among other things, an elastic layer 155 with an inner surface 160 and outer surface 165. In this view, only the outer surface 165 is visible, as the inner surface is bonded to the mesh reinforcement layer 170, and mesh reinforcement layer 170 is bonded to the lap seal tape adhesive layer 175.

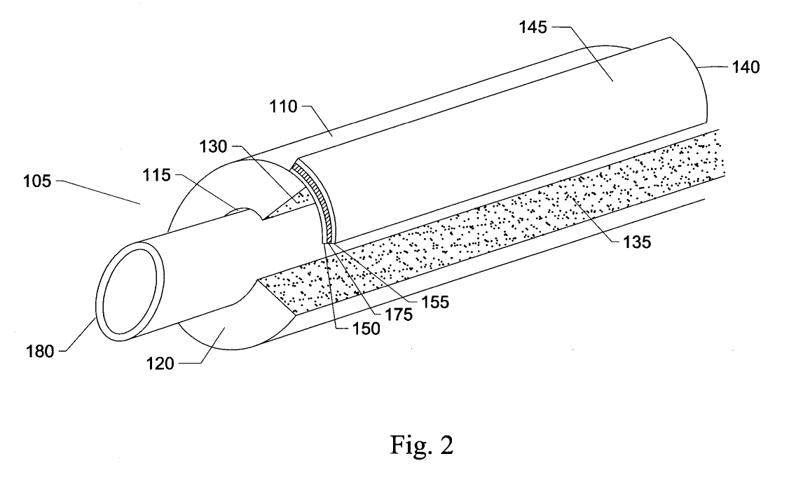

FIG. 2 illustrates a perspective view of the pipe insulation system 100 of this invention which has been partially installed on a pipe, that is, the tubular structure 105 has been opened and placed around a pipe 180 to be insulated. However, in FIG. 2, neither the seam seal nor the lap seal are closed or formed. The view in FIG. 2 illustrates the tubular structure 105 with its outer surface 110, an inner surface 115, a body 120, and the first mating surface 130 and the second mating surface 135 that are defined by the radial slit 125. The lap seal tape structure 140 is also shown with its distal face 150 extending along and facing the second mating surface 135. The elastic layer 155, the mesh reinforcement layer 170, and the lap seal tape adhesive layer 175 of the lap seal tape structure 140 are also illustrated. Typically, at least one of the first mating surface and the second mating surface can be at least partially coated with a mating surface adhesive layer, wherein at least one mating surface release liner that substantially covers and can be attached releasably to the mating surface adhesive layer. As can be envisioned in FIG. 2, in the closed form of the pipe insulation system, the first mating surface and the second mating surface can be joined by way of the mating surface adhesive layer, and the lap seal tape structure can be attached to the outer surface of the tubular structure by way of the lap seal tape adhesive layer, such that the radial slit extends substantially the length of the lap seal tape structure, and such that the lap seal tape structure is bonded to the outer surface of the tubular structure on both sides of the radial slit.

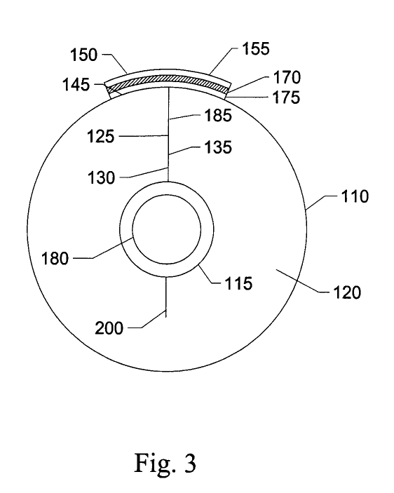

The pipe insulation system 100 of this invention, as seen in this end view, can be installed on a pipe, as illustrated in FIG. 3, and held in the fully closed or sealed position by both the seam seal and the lap seal. The first mating surface 130 and a second mating surface 135 are joined or bonded by the mating surface adhesive layer 185, such that the seam seal is formed and the pipe 180 is enclosed. The lap seal tape structure 140, the proximal face 145, the distal face 150, the elastic layer 155, the mesh reinforcement layer 170, the lap seal tape adhesive layer 175 also are shown applied over the seam seal and spanning the first and second mating surfaces, to form the flexible lap seal tape structure along and over the seam seal. FIG. 3. also illustrates an optional second radial slit 200 in the inner surface of the tubular structure, extending only partially through the body and extending parallel to the longitudinal axis of the tubular structure. As described, this slit can define a longitudinally extending hinge that assists in opening the tubular structure and installing it around a pipe. The second radial slit 200 illustrated in the exemplary embodiment in FIG. 3 can have a depth of about 0.5 times the radially extending thickness of the body 120.

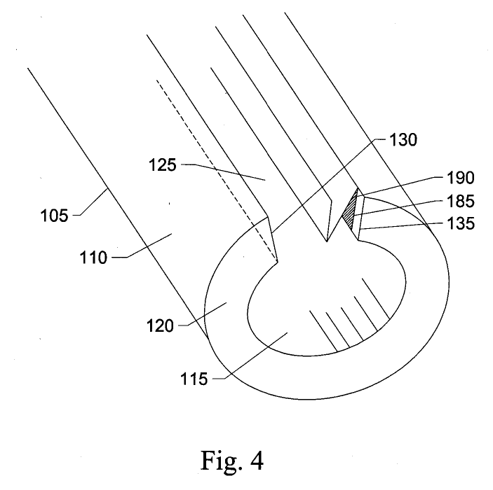

FIG. 4 illustrates a perspective view of the tubular structure 105 of the pipe insulation system with its outer surface 110 and inner surface 115, and particularly emphasizing the first mating surface 130 and the second mating surface 135 defined by the radial slit 125 that extends through the body 120, the mating surface adhesive layer 185, a portion of which has been removed, and the mating surface release liner 190, a portion of which has been peeled back. When the mating surface release liner 190 is removed, the first mating surface 130 and the second mating surface 135 are bonded by way of the mating surface adhesive layer 185 to form the seam seal.

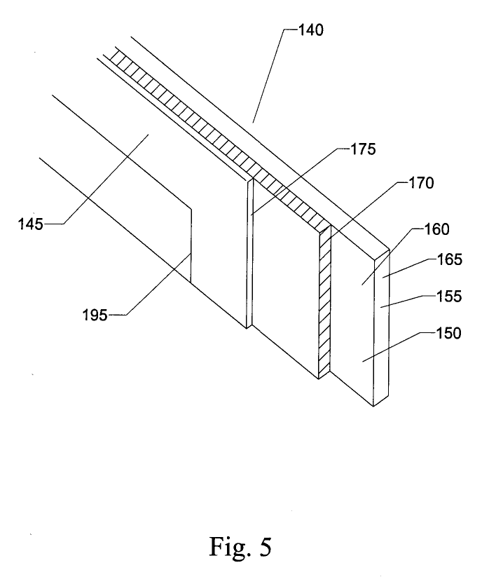

As additionally shown in FIG. 5, the lap seal tape structure 140 is provided in which portions of the mesh reinforcement layer 170, the lap seal tape adhesive layer 175, and the lap seal tape release liner 195 have been removed. In this view, the proximal face 145 and the distal face 150 of lap seal tape structure 140 can be illustrated, as can the elastic layer 155 with its inner surface 160 and outer surface 165. In this perspective, the mating surface release liner 190 has not been peeled back, rather a portion is not shown to illustrate the underlying layers.

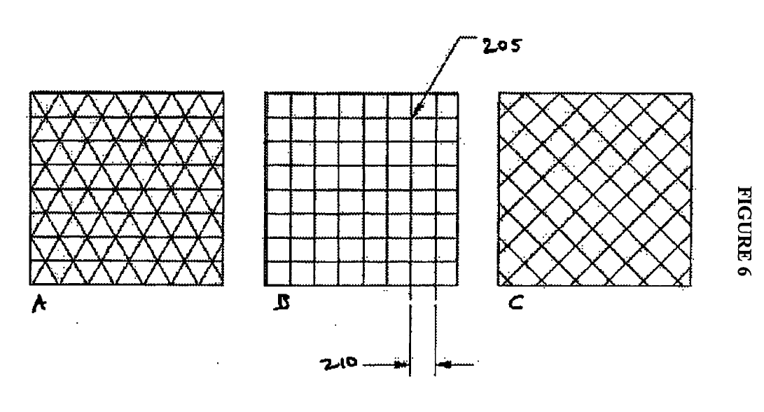

FIG. 6 illustrates some non-limiting examples of mesh reinforcement layer structure types that can be used in the lap seal tape structure of the present invention. These structures include, but are not limited to, a network pattern (A), a netting pattern (B), and a diamond pattern (C) as shown, as well as any type of hatch, weave, or other mesh-type of structure that is not illustrated in this figure. A typical strand intersection 205 and strand spacing 210 a of one mesh structure are shown. The Example provided herein illustrates some specific, non-limiting strand intersection 205 and a strand spacing 210 parameters that can be used in some of the mesh reinforcement layers for the lap seal tape structure of the present invention.

Although any methods, devices, and materials similar or equivalent to those described herein can be used in the practice or testing of the invention, the typical methods, devices and materials are herein described. All publications and patents mentioned herein are incorporated herein by reference for the purpose of describing and disclosing, for example, the constructs and methodologies that are described in the publications, which might be used in connection with the presently described invention. The publications discussed herein are provided solely for their disclosure prior to the filing date of the present application. Nothing herein is to be construed as an admission that the inventors are not entitled to antedate such disclosure by virtue of prior invention. However, to the extent that any definition or usage provided by any document incorporated herein by reference conflicts with the definition or usage provided herein, the definition or usage provided herein controls.

When Applicants disclose or claim a range of any type, for example a range of temperatures, a range of concentrations, a range of numbers of atoms, a weight percent, or the like, Applicants' intent is to disclose or claim individually each possible number that such a range could reasonably encompass, as well as any sub-ranges and combinations of sub-ranges encompassed therein. Thus, when the Applicants disclose or claim a chemical moiety having a certain number of carbon atoms, Applicants' intent is to disclose or claim individually every possible number, sub-range, and combination of sub-ranges that such a number range could encompass, consistent with the disclosure herein. For example, if Applicants disclose that the elastic foam layer of the lap seal tape structure comprises a polymer having a density from about 3 lb/ft³ to about 5 lb/ft³, or in the alternative language from about 3-5 lb/ft³, as used herein, Applicants' intent is to disclose a polymer having a density about 3.1 lb/ft³, about 3.2 lb/ft³, about 3.3 lb/ft³, about 3.4 lb/ft³, about 3.5 lb/ft³, about 3.6 lb/ft³, 3.7 lb/ft³, about 3.8 lb/ft³, about 3.9 lb/ft³, about 4.0 lb/ft³, about 4.1 lb/ft³, about 4.2 lb/ft³, about 4.3 lb/ft³, about 4.4 lb/ft³, about 4.5 lb/ft³, about 4.6 lb/ft³, 4.7 lb/ft³, about 4.8 lb/ft³, about 4.9 lb/ft³, and about 5.0 lb/ft³, as well as any range, combination of ranges, subrange, or combination of subranges between any of these numbers.

The present invention is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, may suggest themselves to one of ordinary skill in the art without departing from the spirit of the present invention or the scope of the appended claims.

### EXAMPLE

Referring to the figures provided herein, the following Table illustrates some of the structural parameters for both the elastic layer and the mesh reinforcement layer that can be used in the lap seal tape structures of this invention. This table specifically illustrates elastic foam layer materials. The data provided in this Table are illustrative only, and are not to be construed as limiting the present invention to these parameters. Any numerical values are to be construed as referring to “about” the values recited.

TABLE
Selected structural parameters for components of the lap seal
tape structure.

| | |
|---|---|
| Structural Parameter | Example |

Elastic Foam Layer

| | |
|---|---|
| Thickness | from about 0.063 in. to about 0.250 in. |
| Density | from about 0.5 lb/ft³ to about 5 lb/ft³ |
| Cell Structure | open, closed, or any percent combination thereof |

Mesh Reinforcement Layer

| | |
|---|---|
| Pattern | Network, Netting, Diamond, or a combination |
| | thereof |
| Strand Diameter | from about 0.001 in. to about 0.010 in. |
| Strand (Intersection) | from about 0.01 in. to about 0.20 in. |
| Spacing | |

We claim:

1. A pipe insulation system comprising:
a) a tubular structure of an insulation material defining a longitudinal axis, wherein the tubular structure comprises:
i) a substantially cylindrical outer surface,
ii) a substantially cylindrical inner surface defining a longitudinally extending passage, and
iii) a body extending between the cylindrical outer surface and the cylindrical inner surface and having a radially extending thickness; and
iv) a radial slit extending through the body parallel to the longitudinal axis of the tubular structure for the length of the tubular structure, wherein the radial slit defines a first mating surface and a second mating surface; and
b) a lap seal tape structure having a longitudinal axis, a proximal face, and a distal face, wherein the longitudinal axis of the lap seal tape structure extends substantially parallel to the longitudinal axis of the tubular structure for the length of the tubular structure, and the lap seal tape structure comprising:
i) an elastic layer having an inner surface and an outer surface, the outer surface forming the distal face of the lap seal tape structure;
ii) a mesh reinforcement layer applied to the inner surface of the elastic layer; and
iii) a lap seal tape adhesive layer having at least a portion bonded to the mesh reinforcement layer and the elastic layer and forming the proximal face of the lap seal tape structure;
wherein a portion of the lap seal tape structure is bonded to the outer surface of the tubular structure on one side of the radial slit by engagement of at least a portion of the lap seal tape adhesive layer, such that the radial slit extends substantially along the length of the lap seal tape structure and defines the portion of the lap seal tape adhesive layer bonded to the outer surface of the tubular structure.

2. A pipe insulation system according to claim 1, wherein at least one of the first mating surface and the second mating surface is at least partially coated with a mating surface adhesive layer, and optionally, wherein at least one mating surface release liner is releasably attached to the mating surface adhesive layer.

3. A pipe insulation system according to claim 1, wherein at least one of the first mating surface and the second mating surface is at least partially coated with a mating surface adhesive layer, and wherein the first mating surface and the second mating surface are joined by engagement of the mating surface adhesive layer therebetween.

4. A pipe insulation system according to claim 1, wherein the mesh reinforcement layer of the lap seal tape structure substantially covers the elastic layer.

5. A pipe insulation system according to claim 1, wherein the lap seal tape adhesive layer substantially covers the mesh reinforcement layer of the lap seal tape structure.

6. A pipe insulation system according to claim 1, further comprising a lap seal tape release liner that substantially covers and is releasably attached to the lap seal tape adhesive layer.

7. A pipe insulation system according to claim 1, wherein the proximal face of the lap seal tape structure is attached to the outer surface of the tubular structure on both sides of the radial slit by engagement of the lap seal tape adhesive layer therebetween.

8. A pipe insulation system according to claim 1, wherein the mesh reinforcement layer comprises a material selected from a woven textile made from natural fibers, a non-woven textile made from natural fibers, a woven textile made from synthetic fibers, a non-woven textile made from synthetic fibers, or any combination thereof.

9. A pipe insulation system according to claim 1, wherein the mesh reinforcement layer comprises a material selected from cotton, wool, flax, linen, hemp, jute, silk, ramie, sisal, rayon, acetate, nylon, modacrylate, polyolefin, polyester, acrylic polymers, polyacrylonitrile, aramid, vinalon, fiberglass, any composite thereof, or any combination thereof.

10. A pipe insulation system according to claim 1, wherein the mesh reinforcement layer is characterized by a network pattern, a netting pattern, or a diamond pattern.

11. A pipe insulation system according to claim 1, wherein the tubular structure comprises a closed-cell foam material selected from polyurethane, polyethylene, polypropylene, polystyrene, poly(vinyl chloride), synthetic butadiene rubber, polyamide, poly(ethylene-co-vinyl-acetate), poly(ethylene-propylene-diene), styrene-butadiene-rubber, neoprene, polyisoprene, polychloroprene, or any combination thereof.

12. A pipe insulation system according to claim 1, wherein the insulation material of the tubular structure comprises a closed-cell foam material having a density from about 7 to about 1 lb/ft³.

13. A pipe insulation system according to claim 1, wherein the insulation material of the tubular structure comprises a closed-cell foam having a water vapor permeability rating of about 0.05 perm or less.

14. A pipe insulation system according to claim 1, wherein the radially extending thickness of the tubular structure body is from about 0.10 inches to about 10 inches.

15. A pipe insulation system according to claim 1, wherein the tubular structure further comprises a second radial slit in the inner surface of the tubular structure, extending partially through the body, parallel to the longitudinal axis of the tubular structure, wherein the second radial slit defines a longitudinally extending hinge in the tubular structure.

16. A pipe insulation system according to claim 17, wherein the second radial slit has a depth from about 0.1 times to about 0.9 times of the radially extending thickness of the tubular structure body.

17. A lap seal tape structure comprising:
a) an elastic layer;
b) a mesh reinforcement layer applied to one surface of the elastic layer and substantially coextensive with the elastic layer; and
c) a lap seal tape adhesive layer bonded to the mesh reinforcement layer and the elastic layer and substantially coextensive with the mesh reinforcement layer.

18. A lap seal tape structure according to claim 17, further comprising a lap seal tape release liner releasably attached to the lap seal tape adhesive layer and extending substantially coextensive with the lap seal tape adhesive layer.

19. A pipe insulation system comprising:
a) a tubular structure of an insulation material defining a longitudinal axis, wherein the tubular structure comprises:
i) a substantially cylindrical outer surface,
ii) a substantially cylindrical inner surface defining a longitudinally extending passage, and
iii) a body extending between the cylindrical outer surface and the cylindrical inner surface and having a radially extending thickness;
iv) a radial slit extending through the body parallel to the longitudinal axis of the tubular structure for the length of the tubular structure, wherein the radial slit defines a first mating surface and a second mating surface;
v) a mating surface adhesive layer at least partially coating at least one of the first mating surface and the second mating surface; and
vi) a release liner releasably attached to the at least one mating surface adhesive layer; and
b) a lap seal tape structure having a longitudinal axis, a proximal face, and a distal face, wherein the longitudinal axis of the lap seal tape structure extends substantially parallel to the longitudinal axis of the tubular structure for the length of the tubular structure, and the lap seal tape structure comprising:
i) an elastic layer having an inner surface and an outer surface, the outer surface forming the distal face of the lap seal tape structure;
ii) a mesh reinforcement layer applied to the inner surface of the elastic layer;
iii) a lap seal tape adhesive layer having at least a portion bonded to the mesh reinforcement layer and the elastic layer and forming the proximal face of the lap seal tape structure;
wherein a portion of the lap seal tape structure is bonded to the outer surface of the tubular structure on one side of the radial slit by engagement of at least a portion of the lap seal tape adhesive layer, such that the radial slit extends substantially along the length of the lap seal tape structure and defines the portion of the lap seal tape adhesive layer bonded to the outer surface of the tubular structure; and
iv) a lap seal tape release liner that substantially covers and is releasably attached to the portion of the lap seal tape adhesive layer that is not bonded to the outer surface of the tubular structure.
